(19) United States
(12) Patent Application Publication
(10) Pub. No.: US 2009/0049613 A1
(43) Pub. Date: Feb. 26, 2009

(54) Patient Supporting Device

(76) Inventors: Thomas Dippl, Pressath (DE); Klaus Hruschka, Erbendorf (DE); Mario Ring, Kemnath (DE); Josef Rupprecht, Erbendorf (DE)

Correspondence Address: BRINKS HOFER GILSON & LIONE, P.O. BOX 10395, CHICAGO, IL, 60610, US

(21) Appl. No.: 11/887,873

(22) PCT Filed: Mar. 31, 2006
(86) PCT No.: PCT/EP2006/061210

§ 371 Date: Oct. 3, 2007

(30) Foreign Application Priority Data
Apr. 4, 2005 (DE) 10 2005 015 392.5

(51) Int. Cl. A61G 13/06; B66F 3/22

(52) U.S. Cl. 5/611

(57) ABSTRACT

The invention relates to a patient-supporting device for a diagnostic and/or therapeutic appliance, with a bench which is mounted so as to be vertically adjustable, and with a spindle drive which is designed for adjusting the height of the bench. According to the invention, the spindle drive is mounted on a base plate in a ball joint in order to avoid a situation where errors of alignment between spindle nut and spindle can be caused by a patient not being centered on the bench.

The present patent document is a §371 nationalization of PCT Application Serial Number PCT/EP2006/061210, filed Mar. 31, 2006, designating the United States, which is hereby incorporated by reference. This patent document also claims the benefit of DE 10 2005 015 392.5, filed Apr. 4, 2005, which is also hereby incorporated by reference.

### BACKGROUND

The present embodiments relate to a patient-supporting device.

In medical diagnostics and therapeutics, appliances are used in which a patient is examined or treated using radiation, electromagnetic waves, or sound waves. X-ray, electron or particle beams, ultrasound waves, or magnetic fields are used in the examination or treatment, for example. The devices may include relatively heavy sources of radiation or active sources, and corresponding detectors. The devices may be positioned in the space using correspondingly solid mechanical constructions, with completely flexible three-dimensional positioning not usually being possible.

Depending on the type of examination or treatment to be carried out, the diagnostic or therapeutic appliance and/or its active source must be placed in a certain spatial orientation and positioned in relation to the patient to be examined. The adjustment of the necessary spatial constellation is supported by devices that can be positioned in the space. However, because the positioning capability is normally always restricted, it is not possible to set up each and every spatial constellation of patient and device. It may be necessary, depending on the type of examination or treatment, for the patient to be positioned in a certain way, for example, lying on the back or side, head-down or in a standing position, or in other positions. Therefore, a patient-supporting device is used. The patient can be positioned in relation to the device with the help of the patient-supporting device. The ability to position the device and the patient at the same time increases the range of potential spatial constellations.

A patient-supporting device may be used to provide one or two-dimensional movement in a geodetically horizontal plane for positioning a patient. Patient-supporting tables may be used to provide the one or two-dimensional movement. The patient-supporting table may have a patient support as a tabletop, which is mounted in a floating fashion. This floating mounting may (or may not) include linear control so that the patient support can be adjusted through one or two dimensions. The height of the patient support may be adjusted. A lifting device may be used to adjust the height of the patient support, which is oriented in a geodetically vertical direction and which raises or lowers the patient support, generally from underneath. The lifting device may comprise a hydraulic, pneumatic or electromotive drive and have a pantograph-type parallelogram, or spindle-drive mechanism. Other positioning options may be achieved by the patient support having a tilting facility. By combining all the adjustment options it is possible to achieve the greatest possible flexibility in the positioning of the patient support and thus of the patient.

In medical practice, it is important, in addition to the ability to position the patient, that access to the patient is as unimpeded and flexible as possible. During treatment or examination, medical or technical staff must be able to reach the patient at all times. Patient-supporting devices may include stands that are as slim as possible and have the smallest possible footprint that support the patient support. The center of gravity of a patent lying on the patient support, depending on how the patient is positioned, may not always be situated over the stand. A patient that is not positioned centrally over the stand causes a torque on the stand. This torque may increase significantly if the patient support is moved horizontally, because of the resulting increase in the length of the lever. Thus, in the construction of the stand, a compromise must be reached between minimum size and maximum stability.

In highly adjustable patient-supporting devices, the lifting device for adjusting height may be accommodated in the stand and may be subject to the compromise described above, as well as to the described torque strain. The torque caused by a patient lying eccentrically results in the vertically-oriented lifting device being subject to torsional or shearing load. This load may lead to errors of alignment being caused in drive components that need to be vertically aligned. Errors of alignment may occur, for example, for a hydraulic cylinder and piston in a hydraulic device, or for spindle and nut in a spindle drive.

A hydraulic device normally guarantees relatively high lateral traction forces and therefore already inherently counteracts errors of alignment. Spindle drives are subject to the described problem of errors of alignment. Thus it is known, for example, for the height adjustment of the patient support to be implemented by a construction in which a parallelogram or dual-parallelogram construction is driven by a spindle drive. The parallelogram or dual-parallelogram construction may be connected to a base plate of the patient-supporting device by a fixed bearing. The spindle of the spindle drive, with a drive motor, forms a structural unit that is fixed to the base plate. The structural unit including spindle and drive is connected to the base plate such that the spindle is vertically oriented. The spindle nut is arranged on the parallelogram or dual-parallelogram construction such that it is in alignment with the spindle. If the construction is subjected to the strain of a patient lying eccentrically, the resulting torque causes the parallelogram or dual-parallelogram construction to depart slightly from its originally vertical orientation due to elastic deformation. This also causes the spindle nut connected to it to move out of position or alignment and, to be no longer aligned with the spindle.

The errors of alignment between spindle and spindle nut may be counteracted by the spindle nut being manufactured from a relatively soft material, for example, plastic or bronze. Alternatively, the errors of alignment between spindle and spindle nut may be counteracted by providing a certain clearance between spindle und spindle nut. The certain clearance enables the spindle drive to be operated reliably despite the occurrence of minor errors of alignment. This nevertheless increases both friction and wear between spindle and spindle nut.

WO 98/46137 discloses a patient-supporting device, which incorporates a dual-parallelogram construction for height adjustment purposes. The dual-parallelogram construction is solidly dimensioned and equipped with a plurality of twin parallelogram arms. The patient-supporting device may be operated by a hydraulic drive, a spindle drive, or a direct rotator drive of a parallelogram arm. Errors of alignment in the drive components, however, are not specifically taken into account except by the solidly designed construction and may therefore cause increased wear.

### SUMMARY

The present embodiments may obviate one or more of the drawbacks or limitations inherent in the related art. For example, in one embodiment, a patient-supporting device for a diagnostic and/or therapeutic appliance and a diagnostic and/or therapeutic appliance with a patient-supporting device includes a spindle drive for height adjustment of a patient support. The spindle drive takes up little construction space and in which wear and friction are reduced at the same time.

The spindle drive is mounted on the base plate of the patient-supporting device in a ball joint. This mounting permits rotation of the spindle around the rotational center of the ball joint. If the patient support of the patient-supporting device is subject to eccentric strain caused by a patient not lying centrally, then the parallelogram construction is displaced away from its vertical orientation, resulting in the orientation of the spindle drive being altered. By rotation around the ball joint, however, the spindle drive may follow the displacement and maintain the alignment between spindle and spindle nut. As a result of the alignment being maintained, any increase in wear and friction caused by eccentric strain on the patient support is prevented or at least minimized.

In one embodiment, the ball joint is arranged in alignment with the spindle of the spindle drive. As a result, the load caused by the patient support resting on the spindle and by the patient lying on the patient support is conducted via the spindle centrally to the ball joint, whereby friction and wear within the ball joint are minimized. The ball joint retains optimum maneuverability and is more able to equalize errors of alignment in the spindle drive.

In one embodiment, the stand includes a dual parallelogram construction, which is driven by the spindle drive. A fixed bearing and a moveable bearing are mounted on the base plate for each parallelogram of the dual parallelogram construction. Mounting a fixed bearing is particularly inexpensive in terms of construction.

In one embodiment, the fixed bearing and the spindle alignment define a common level, which allows particularly smooth interaction of spindle drive and parallelogram movement.

In one embodiment, the rotational center of the ball joint is located on an axis running through the fixed bearing. Assuming that any eccentric loading of the patient support leads to a displacement of the dual parallelogram construction, mainly in the form of a rotation around the fixed bearings, the common axis of fixed bearings and ball joint ensures that the spindle drive can be displaced around the same rotational axis. As a result, errors of alignment in the spindle drive caused by eccentric loading of the patient support may be prevented to a particular extent.

In one embodiment, the spindle drive is operated by a drive, which is rigidly connected to the spindle. The rigid connection prevents the connection between spindle and drive from being altered during a rotation of the spindle around the ball joint. There is no need for variable transmission of the motive force of the drive to the spindle to be provided, as would be necessary between a fixed drive and a rotating mounted spindle during rotational displacement of the spindle; in this case, the distance or orientation of the spindle relative to the drive would be altered during the rotation of the spindle.

In one embodiment, the drive and the spindle are mounted on the base plate in a moveable fashion. The drive and spindle may be mounted on spring or elastic elements, for example, on rubber buffers. This moveable mounting helps to bear the weight of the drive, such as in constructions in which the drive mass is not arranged with rotational symmetry around the rotational center of the ball joint. In this kind of eccentric drive arrangement, any torque exerted on the spindle by the drive mass is prevented by the drive mounting. The mounting can be moved to the extent that rotation around the ball joint is still possible. The suppression of torque exerted by the drive on the spindle effectively minimizes friction and wear in the spindle drive.

In one embodiment, the drive, which is mounted in a moveable fashion, includes a lug that fits into a locking element fixed to the base plate. Since the drive causes the spindle to rotate, it is protected against rotation. A lug fitting into a locking element provides a relatively inexpensive locking element in terms of construction.

### BRIEF DESCRIPTION OF THE DRAWINGS

FIG. 1 illustrates a diagnostic and/or therapeutic appliance with patient-supporting device in one embodiment,

FIG. 2 illustrates one embodiment of a parallelogram construction and spindle drive of a patient-supporting device,

FIG. 3 illustrates an embodiment of the ball joint mounting of the spindle drive, and

FIG. 4 illustrates the ball joint in one embodiment.

### DETAILED DESCRIPTION

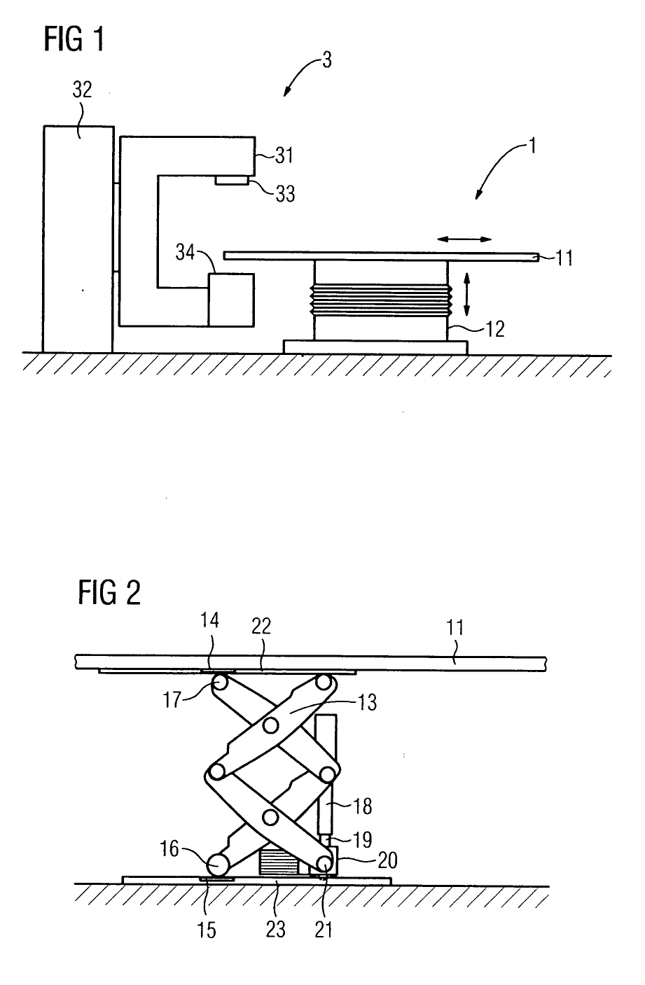

FIG. 1 is a schematic illustration of a diagnostic and/or therapeutic appliance (DT appliance) 3 with a patient-supporting device 1. The DT appliance 3 includes a C-arc 31, which holds an x-ray emitter 33 and an x-ray detector 34. The C-arc 31 may, for example, be used with low-power x-radiation for generating x-ray images, or with high-power x-radiation for therapeutic irradiation. The C-arc 31 is mounted in a C-arc pedestal 32. The C-arc pedestal 32 may include a freestanding construction in the room or a construction mounted on the wall or ceiling of the room. The C-arc 31 enables the x-ray emitter 33 and the x-ray detector 34 to be positioned such that a patient positioned with the help of the patient-supporting device 1 can be detected by the x-ray beam.

The patient-supporting device 1 includes a patient support (patient couch) 11 on which a patient can lie. The patient support 11 may be moved horizontally, as indicated by a horizontal double-ended arrow. The patient support 11 is mounted in a floating fashion on a stand 12. The height of the patient support 11 can be adjusted. The stand 12 incorporates a lifting device (not shown in greater detail in FIG. 1) to adjust the height. The height adjustability is indicated by a vertical double-ended arrow.

FIG. 2 is a schematic diagram showing components of the lifting device of the patient-supporting device 1. The lifting device includes a base plate 23 arranged or integrated in the stand 12, on which a dual parallelogram construction 13, for example, a construction consisting of two individual parallelograms arranged one over the other, is mounted. The dual parallelogram construction 13 is vertically oriented, such that activation causes it to be shortened or elongated in a vertical direction. The shortening or elongation of the dual parallelogram construction 13 is used for height adjustment of the lifting plate 22 mounted on the parallelogram construction 13. The patient support 11 is connected to the lifting plate 22, so that the dual parallelogram construction 13 is used for height adjustment of the patient support 11 and thus of a patient lying on the patient support 11.

The dual parallelogram construction 13 is mounted on the base plate 23 by a fixed bearing 21. On the opposite side it is mounted in the base plate by a moveable bearing 16, which includes a sliding bearing 15. The combination of fixed bearing 21 and moveable bearing 16 permits activation of the dual parallelogram construction 13. To permit movement opposite the lifting plate 22, the lifting plate 22 is mounted on the dual parallelogram construction 13 by a moveable bearing 17, which includes a sliding bearing 14 on the lifting plate 22. Above the fixed bearing 21, the dual parallelogram construction 13 may be connected to the lifting plate 22 by a fixed bearing.

The dual parallelogram construction 13 is activated via a spindle drive. The spindle drive includes a spindle nut 18 and a spindle 19, which are connected to the dual parallelogram construction 13. Rotation of the spindle 19 causes the height of the spindle nut 18, and thus the length of the parallelogram construction 13, to be adjusted. Rotation of the spindle 19 is driven by a drive 20. The drive 20 is connected to the spindle 19 such that it can rotate the spindle 19. The drive 20 may be an electric motor, but could also be activated hydraulically, pneumatically, manually or by foot.

From the diagram it may be seen that an eccentric loading of the patient support 11, indicated by a downward-pointing arrow on the right of the diagram, causes a torque to be exerted on the dual parallelogram construction 13, clockwise according to the arrow. This torque may cause an elastic displacement, which affects the spindle nut 18. The spindle nut 18 is displaced out of alignment with the spindle 19. The displacement causes friction and wear in the spindle drive 20 to increase.

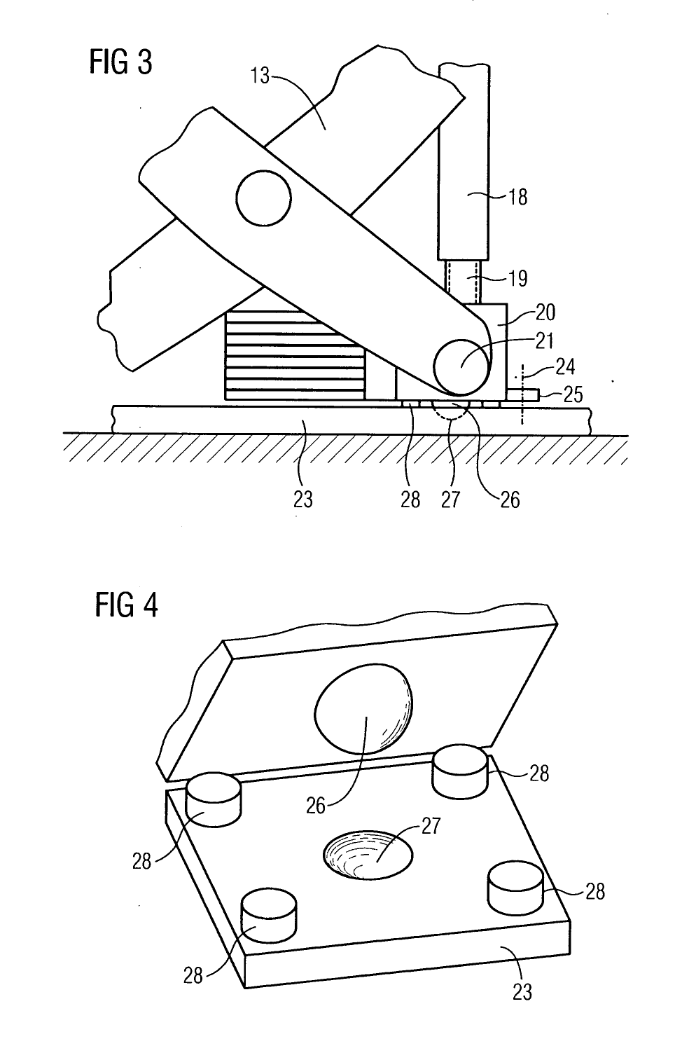

The spindle drive, as shown in FIG. 3, includes a ball joint. The dual parallelogram construction 13 and the spindle nut 18 can be seen in FIG. 3. The connection point between dual parallelogram construction 13 and the spindle nut 18 is not shown in FIG. 3. The spindle 19 is rigidly connected to the drive 20, so that the drive 20 can rotate the spindle 19. The structural unit formed by the drive 20 and the spindle 19 is mounted in the base plate 23 via a ball joint. The base plate 23 includes a ball cup 27. The ball cup 27 includes an arc angle section of approx 90°. Drive 20 and spindle 19 are mounted in the ball cup 27 by a spherical head 26. The spherical head 26 and ball cup 27 may be made of a suitable material, be hardened or have bearing shells or bearing surfaces that effectively minimize friction and wear. Bearing surfaces of this type are not shown in greater detail in FIG. 3.

In FIG. 3, the drive 20 is arranged eccentrically in relation to the rotational axis of the spindle 19. The drive 20 is also arranged eccentric in relation to the ball joint and thus, because of its weight, causes a torque of the spindle drive 20, the torque being shown anti-clockwise in the diagram. To counteract this torque, the drive 20 is mounted on spring or elastic elements, such as rubber buffers 28. Elastic mounting elements could be used instead of rubber buffers, for example, on the basis of steel sprung elements. The rubber buffers 28 produce a moveable mounting, wherein they permit movements of the drive around the ball joint to a small degree. The rubber buffers 28 also cause the drive 20 to be effectively self-supporting from the outset, so that it does not exert any torque on the spindle drive. The rubber buffers 28 are dimensioned such that the drive 20 remains stable in the position shown. For this purpose the rubber buffers 28 are not arranged around the ball joint symmetrically, but are eccentric such that the eccentric part of the mass of the drive 20 is more firmly supported.

The moveable mounting of the drive 20 must be restricted to the extent that the drive 20 is able to exert a rotational force on the spindle 19. It must therefore itself be protected against rotation, despite the mounting being moveable. A lug 25, which is fixed to the drive 20, fits into a locking element 24 fixed to the

1. A patient-supporting device for a diagnostic and/or therapeutic appliance, the patient-supporting device comprising:
a patient support being height-adjustable,
a spindle drive being operable to adjust the height of the patient support, and
a stand incorporating a base plate, wherein the spindle drive is mounted on the base plate in a ball joint.

2. The patient-supporting device as claimed in claim 1, wherein the ball joint is in alignment with a spindle of the spindle drive.

3. The patient-supporting device as claimed in claim 1, wherein the stand includes a dual parallelogram construction, which is operated by the spindle drive, the dual parallelogram construction being mounted on the base plate in a fixed bearing and a moveable bearing.

4. The patient-supporting device as claimed in claim 3, wherein the fixed bearing and the alignment of the spindle define a common level.

5. The patient-supporting device as claimed in claim 4, wherein the rotational center of the ball joint is located on one of the axes running through the fixed bearing.

6. The patient-supporting device as claimed in claim 2, wherein the spindle drive is operated by a drive that is fixed to the spindled.

7. The patient-supporting device as claimed in claim 6, wherein the drive is moveably mounted on the base plate.

8. The patient-supporting device as claimed in claim 7, wherein the drive includes a lug that fits into a locking element fixed to the base plate.

9. A diagnostic and/or therapeutic appliance with a patient-supporting device, the appliance comprising:
a patient support being height-adjustable,
a spindle drive being operable to adjust the height of the patient support, and
a stand incorporating a base plate,
wherein the spindle drive is mounted on the base plate in a ball joint.

10. The diagnostic and/or therapeutic appliance (3) as claimed in claim 9, wherein the ball joint is in alignment with a spindle of the spindle drive.

11. The patient-supporting device as claimed in claim 9, wherein the stand includes a dual parallelogram construction, which is operated by the spindle drive, the dual parallelogram construction being mounted on the base plate in a fixed bearing and a moveable bearing.

12. The patient-supporting device as claimed in claim 2, wherein the stand includes a dual parallelogram construction, which is operated by the spindle drive, the dual parallelogram construction being mounted on the base plate in a fixed bearing and a moveable bearing.

13. The patient-supporting device as claimed in claim 12, wherein the fixed bearing and the alignment of the spindle define a common level.

14. The patient-supporting device as claimed in claim 13, wherein the rotational center of the ball joint is located on one of the axes running through the fixed bearing.

15. The patient-supporting device as claimed in claim 7, wherein the drive is moveably mounted on elastic or spring elements.

16. The patient-supporting device as claimed in claim 11, wherein the elastic or spring elements are rubber buffers.
